(19) United States
(12) Patent Application Publication
(10) Pub. No.: US 2022/0304900 A1
(43) Pub. Date: Sep. 29, 2022

(54) CLIP ASSEMBLY FOR A BABY PACIFIER

(71) Applicants: Elissa Rae Welnick, Canonsburg, PA (US); Brittany Christina Jones, Bellevue, PA (US)

(72) Inventors: Elissa Rae Welnick, Canonsburg, PA (US); Brittany Christina Jones, Bellevue, PA (US)

(21) Appl. No.: 17/665,443

(22) Filed: Feb. 4, 2022

Related U.S. Application Data
(60) Provisional application No. 63/148,570, filed on Feb. 11, 2021.

(51) Int. Cl. A61J 17/00

(52) U.S. Cl. CPC A61J 17/1115; A61J 17/001

(57) ABSTRACT

A new and alternative way to use a baby pacifier clip without using a metal or plastic at the base. Often, the metal or plastic clips distract the child from the intended use of the clip, the pacifier or teething toy at the other end. The soft band doesn't distract from the main use of the invention. The band is a constructed of elastic and soft fabric with a reinforced hole in the center. A means to attach a pacifier or teething toy to any sort of carrier to stay with the baby.

### BACKGROUND AND SUMMARY

This invention relates generally to the field of baby accessories and more specifically to a pacifier clip or holder.

It's typical for parents to use a pacifier or teething toy to calm a baby, but a problem is when the child is not using the item, tosses it away to fall on the ground, or easily be lost.

While a pacifier clip does exist and have been around for some time, there was still a problem to be solved that turns out a lot of parents also had. So many of the baby clips on the market have a base made from metal or plastic. This often distracts the baby from the intended use of the pacifier and the baby will chew on the clip instead which can be hazardous for numerous reasons. This clip hides a toggle base under a soft material that isn't distracting, leaving the pacifier on the opposite end to be use as intended. Secondly, this will prevent the pacifier or teething toy to stay with the child and not on the floor or to get misplaced.

Another reason there needed to be an alternative solution to metal land plastic clips were the “teeth” used inside to grip to a material. If the child pulls at the pacifier clip, the teeth can damage whatever it was clipped to. With a soft fabric that goes around and not clipped to, it prevents damage.

The last reason there needed to be an alternative pacifier clip was the size. Some baby items that you would use with a pacifier clip are just too thick or too wide or a metal or plastic base. By using a soft fabric, it allows some give to stretch to be able to be connected to thicker or wider products such as baby carriers or diaper bags.

### DETAILED DESCRIPTION

It is typical for most parents to use a pacifier 2 or teething to for their child when their fussy, tired or on the move such as when in a car. With that, it's common for parents to use a pacifier clip to keep the pacifier with the child and off the floor as shown in FIG. 1.

The nylon loop on the end of the strap 4 can be used to connect to pacifiers 2 and teething toys with any sort of loop or hole to pull the nylon 4 through and loop on (as you would any pacifier clip). This is the end that's meant to be focused on by the child.

Each nylon strand 4 has silicon teething beads 6 that can be gripped or used as teething beads to conceal the middle area of the strap and making it a functional piece for the child.

At the opposite end of the looped nylon 4, is a toggle 12, shown in FIGS. 2, 3, 4 and 5 that is designed for this pacifier clip. The toggle 12 at each base is a small, soft, slightly flexible material constructed with two holes 16 for the nylon to loop 4 through. The reasoning for the toggle 12 is that is it made to be soft with a slight flexibility so it can pass through the reinforced hole 10 and turn to T up against the fabric from underneath, causing the clip to lock in place.

The band 8 is a soft fabric with elastic inside allowing it to have some stretch so it can be used on a wider variety of baby products such as carriers, strollers, diaper bags, etc. On each end of the band are two pieces of Velcro 14 used to connect the band 8 around an object and act as a closure as shown in FIGS. 4 and 5. On one end, facing up will be a hook piece of Velcro 14 and on the opposite end of the band, facing down will be a loop piece of Velcro 14. All that's needed is to wrap the band 8 around a strap, for example, and connect the hook and loop Velcro 14 together as shown in FIG. 6.

There is a reinforced hole 10 punched in the center of each band 8 that allows the toggle 12 to pass through and lock in. This is a way to conceal the base end of the pacifier clip.

The clip can be used as a singular unit with a pacifier 2 or teething toy on the end, away from the band 8. The toggle 12, while when connected is meant to be hidden, is made to also be safe for the child. There needed to be a solution away from metal and plastic and a new toggle 12 is the solution.

Once the desired pacifier 2 or toy is looped to the clip, all you must do is thread the toggle 12 through the reinforced hole 10 and turn to a T- like shape that causes it to lock into place. Then the pacifier clip is ready to be attached to the baby product of your choice, whether a car seat or a diaper bag, etc. The band 8 is easy to attach and to remove for the parents from any item.

### SUMMARY BRIEF DESCRIPTION OF THE DRAWINGS

The drawings illustrate the best mode presently contemplated of carrying out the invention. In the drawings:

FIG. 1 is a perspective view of the present invention secured to a strap and a baby pacifier on either end.

FIG. 2 is a perspective view of the toggle used to anchor the pacifier to the band used in FIG. 1

FIG. 3 is a perspective view of the strap of the invention, showing the looped portion at the top attached to the toggle FIG. 2.

FIG. 4 is a perspective view of the invention which illustrates the object holder and the band.

FIG. 5 is a perspective view of the invention which illustrates the object holder being secured to the band with toggle in FIG. 2 and an alternate view of FIG. 4.

FIG. 6 is an elevational view showing an alternate embodiment of the invention.

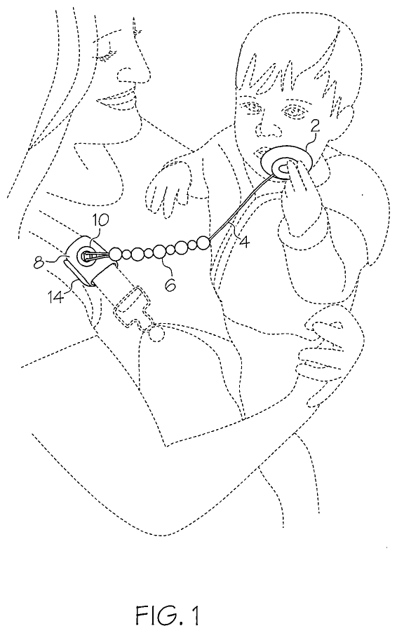

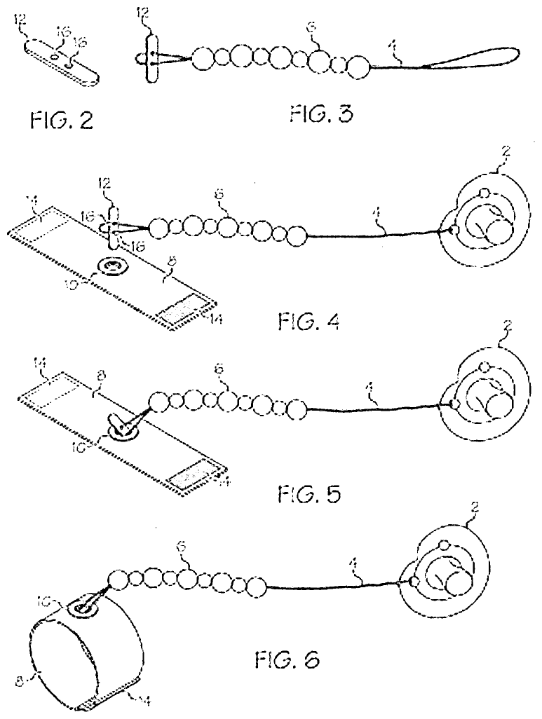

What is claimed:

1. Pacifier clip comprising of a toggle; a soft band with a reinforced hole that once connected can be tethered to any strap on a bag, carrier, or article of clothing.
